(19) United States
(12) Patent Application Publication
(10) Pub. No.: US 2004/0248438 A1
(43) Pub. Date: Dec. 9, 2004

(54) Reinforced substrates with face-mount connectors

(76) Inventor: Marvin Glenn Wong, Woodland Park, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/455,026

(22) Filed: Jun. 5, 2003

(51) Int. Cl. H01R 12/00

(52) U.S. Cl. 439/83

(57) ABSTRACT

Devices and methods are disclosed for reinforcing substrates with face-mount connectors. In one embodiment, the device comprises a fragile substrate including a signal trace, a reinforcement plate bonded to the fragile substrate, and a face-mount connector mated with the reinforcement plate and electrically coupled to the signal trace.

### BACKGROUND OF THE INVENTION

Connectors are used to route power, ground, and signals, to and from electrical circuits on a substrate. Sometimes, the substrates used may be made of a fragile material, such as thin ceramic. Attaching a connector to such a substrate may cause the substrate to break. Assuming that the connector is successfully attached to the substrate, the stress of attaching a cable to a conventional connector may also cause the substrate to break.

Specific connectors may be tooled that have a larger attachment to the substrate, which may prevent the substrate from breaking. However, this may be prohibitively expensive due to the large number of different connector versions within a connector type that may be required for the different types of circuit layouts and products that may be added to the substrate. The expense of tooling specific connectors may be further increased by other requirements, such as minimizing size and the need for high frequency signal integrity, which may limit acceptable connector locations within a circuit and the type and nearness of surrounding circuit elements.

### SUMMARY OF THE INVENTION

Devices and methods are disclosed for reinforcing fragile substrates with face-mount connectors. In one embodiment, a device is disclosed comprising a fragile substrate. The fragile substrate includes a signal trace and is bonded to a reinforcement plate. A face-mount connector is mated with the reinforcement plate and electrically coupled to the signal trace.

### BRIEF DESCRIPTION OF THE DRAWINGS

Illustrative and presently preferred embodiments of the invention are illustrated in the drawings in which:

FIG. 1 illustrates a top-view of a first exemplary device comprising a reinforced substrate and a face-mount connector;

FIG. 2 illustrates an elevation view of the device shown in FIG. 1;

FIG. 3 illustrates a sectional view of the device shown in FIGS. 1 and 2;

FIG. 4 illustrates a sectional view of a second exemplary device comprising a reinforced substrate and a face-mount connector;

FIG. 5 illustrates a sectional view of a third exemplary device comprising a reinforced substrate and a face-mount connector; and

FIG. 6 is a flow diagram illustrating an exemplary method that may be used to construct the devices shown in FIGS. 1-5.

### DETAILED DESCRIPTION

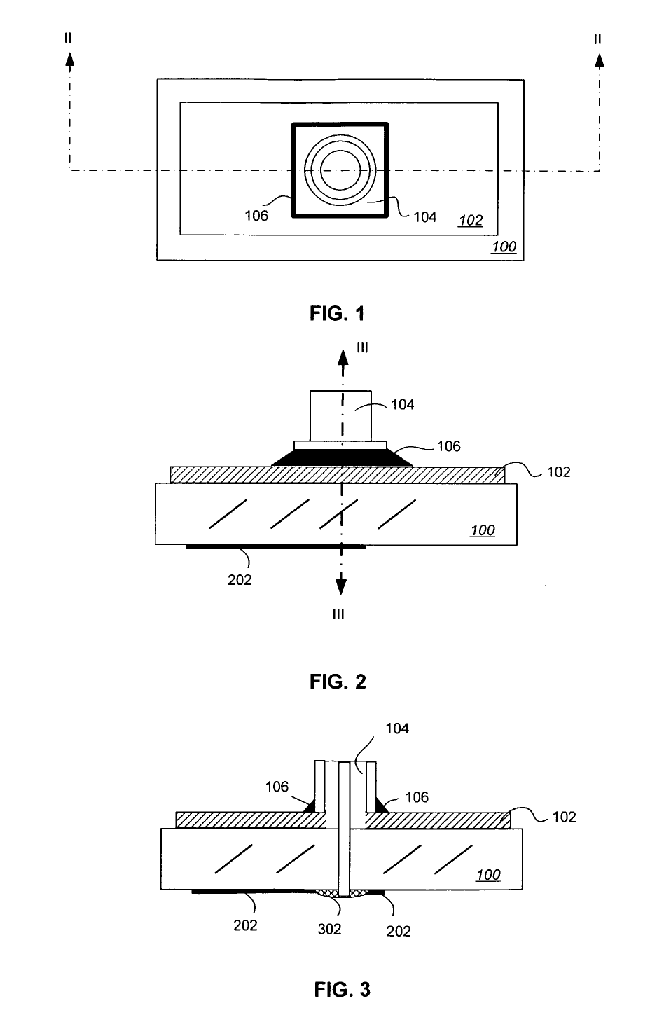

FIGS. 1-3 illustrate a reinforced substrate with a face-mount connector. A substrate 100 is shown. By way of example, the substrate may be a fragile substrate, such as a thin ceramic substrate. Substrate 100 includes circuitry with one signal trace 202. It should be appreciated that in alternate embodiments, substrate 100 may include additional circuitry or circuitry different than that depicted in FIG. 1 (including various combinations of power, ground, or signal traces, as well as attached circuit components).

Reinforcement plate 102 (e.g., plated and/or stamped metal) is bonded to substrate 100. Reinforcement plate 102 may be bonded to substrate 100 with solder, adhesive, or another bonding material. A face-mount connector 104 is mated with reinforcement plate 102 and signal trace 202. It may be used to connect the signal trace 202 of substrate 100 to a cable inserted into the face-mount connector 104. Reinforcement plate 102 may be rectangular, square, or another shape and preferably covers substantially all of one surface of the substrate 100. However, in alternate embodiments, reinforcement plate may cover a smaller area of the substrate 100. It should be appreciated that reinforcement plate 102 may diffuse forces on the fragile substrate 100 caused by mating a cable with face-mount connector 104.

In one embodiment, face-mount connector 104 may be bonded with reinforcement plate 102 with solder 106. Alternatively, an adhesive or another bonding material may be used to bond face-mount connector 104 with reinforcement plate 102. It should be appreciated that reinforcement plate 102 may be grounded to face-mount connector 104 by using a conductive adhesive or solder 106 to electrically couple reinforcement plate 102 to face-mount connector 104. This may cause reinforcement plate 102 to act as a ground plane for circuitry on face-mount connector 104.

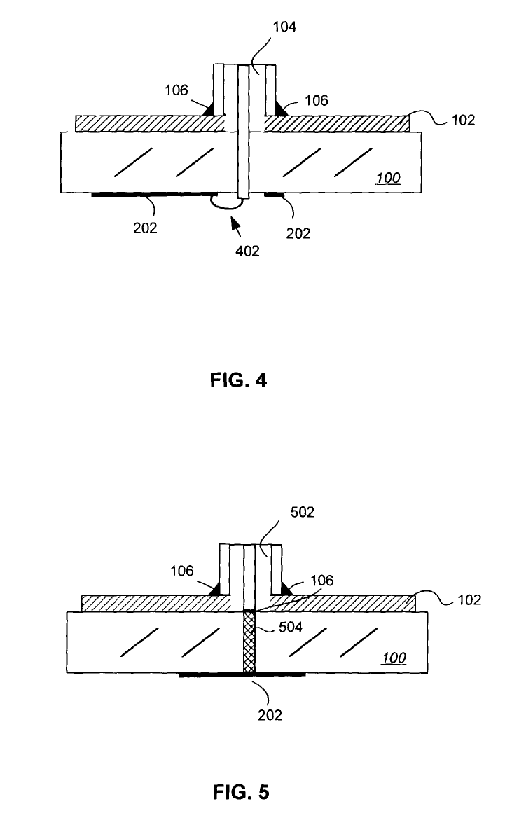

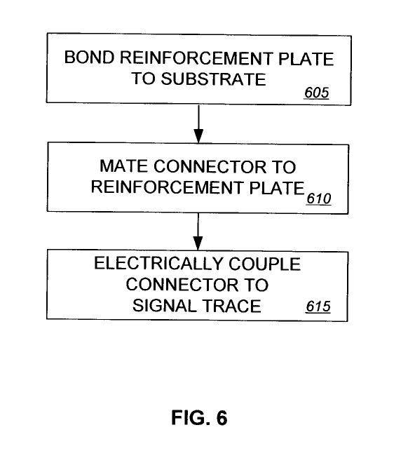

Face-mount connector 104 is further mated with signal trace 202. Face-mount connector 104 may extend through reinforcement plate 102 and substrate 100 and may be soldered to signal trace 202 with solder 302. In other embodiments, as shown in FIG. 4, ribbon wirebond 402 may be used to create a ribbon wirebonded connection between face-mount connector 104 and signal trace 202. Other types of materials, such as conductive adhesive, may also be used to make the connection. Alternately, as shown in FIG. 6, face-mount connector 502 may be mounted over substrate 100 and a conductive via 504 may be used to electrically couple face-mount connector 502 with signal trace 202.

FIG. 6 illustrates an exemplary method that may be used to reinforce fragile substrates with face-mount connectors. A device may be produced by bonding 605 reinforcement plate 102 to substrate 100. By way of example, the reinforcement plate 102 may be bonded to substrate 100 using solder or adhesive. Face-mount connector 104 is mated 610 to reinforcement plate 202. In one embodiment, reinforcement plate 102 may be grounded to face-mount connector 104 by using solder 106 or conductive adhesive to bond reinforcement plate 102 to face-mount connector 104.

Additionally, face-mount connector 104 is mated 615 to signal trace 202 on substrate 100. The connection between face-mount connector 104 and signal trace 202 may be made with solder 302, ribbon wirebond 402, or conductive adhesive. Alternate methods of mating signal trace 202 to substrate 100 are also contemplated.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1: A device comprising:
a fragile substrate including a signal trace;
a reinforcement plate bonded to the fragile substrate; and
a face-mount connector mated with the reinforcement plate and electrically coupled to the signal trace.

2: The device of claim 1, wherein the fragile substrate comprises a ceramic substrate.

3: The device of claim 1, further comprising solder to solder the reinforcement plate to the face-mount connector.

4: The device of claim 1, further comprising adhesive to adhere the reinforcement plate to the face-mount connector.

5: The device of claim 4, wherein the adhesive comprises a conductive adhesive.

6: The device of claim 1, wherein the reinforcement plate is grounded to the face-mount connector.

7: The device of claim 1, further comprising adhesive to bond the fragile substrate to the reinforcement plate.

8: The device of claim 1, further comprising solder to bond the fragile substrate to the reinforcement plate.

9: The device of claim 1, further comprising solder to electrically couple the face-mount connector to the signal trace.

10: The device of claim 1, further comprising adhesive to electrically couple the face-mount connector to the signal trace.

11: The device of claim 1, further comprising ribbon wirebond to create a ribbon wirebonded connection between the face-mount connector and the signal trace.

12: The device of claim 1, wherein the fragile substrate further comprises a conductive via to electrically couple the face-mount connector to the signal trace.

13: A method for reinforcing a fragile substrate, the method comprising:
bonding a reinforcement plate to the fragile substrate, the fragile substrate including a signal trace; and
mating a face-mount connector to the reinforcement plate; and
mating the face-mount connector to the signal trace.

14: The method of claim 13, wherein mating the face-mount connector to the reinforcement plate comprises soldering the reinforcement plate to the face-mount connector.

15: The method of claim 13, wherein mating the face-mount connector to the reinforcement plate comprises applying an adhesive to at least one of the reinforcement plate and the face-mount connector, and adhering the reinforcement plate to the face-mount connector.

16: The method of claim 15, wherein the adhesive comprises a conductive adhesive.

17: The method of claim 13, wherein the substrate comprises a ceramic substrate.

18: The method of claim 13, wherein mating the face-mount connector to the signal trace comprises soldering the signal trace to the face-mount connector.

19: The method of claim 13, wherein mating the face-mount connector to the signal trace comprises mating the signal trace to the face-mount connector using ribbon wirebond.
